(19) United States
(12) Patent Application Publication
(10) Pub. No.: US 2007/0018967 A1
(43) Pub. Date: Jan. 25, 2007

(54) DISPLAY APPARATUS AND TOUCH-BASED METHOD THEREFOR

(76) Inventors: Han-Che Wang, Shenzhen (CN); Shin-Hong Chung, Shenzhen (CN); Kuan-Hong Hsieh, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,784

(22) Filed: May 3, 2006

(30) Foreign Application Priority Data
Jul. 22, 2005 (CN) 200510036135.4

(51) Int. Cl. G09G 5/00

(52) U.S. Cl. 345/173

(57) ABSTRACT

A display apparatus and touch-based method therefor is provided. The touch-based method for the display apparatus includes the steps of: providing the display apparatus including a screen and a frame, the frame connecting the screen and including a first touch sensitive unit and at least a touch sensitive region, the touch sensitive region having a plurality of second touch sensitive units beneath thereof; activating navigation icons on the screen when receiving sensing signals from the first touch sensitive unit, each of the navigation icons indicating a function; and performing the functions indicated by the navigation icons when receiving sensing signals from the second touch sensitive units.

### DESCRIPTION

1. Technical Field

The present invention relates to a display apparatus and touch-based method therefor, and particularly to a display apparatus with touch sensitive units with a frame thereof and a related touch-based method for the display apparatus.

2. General Background

Generally, a display apparatus is a device to visually output information or graphics on a screen. It is widely and increasingly used in electronic devices. A first conventional display apparatus includes a screen to display data (i.e., an image) thereon, and a frame to support the screen. The frame is further disposed a plurality of mechanical function buttons thereon to actuate any desired function. The more functions the display apparatus has, the more mechanical function buttons the frame is disposed thereon. Therefore, the frame should be designed as large as possible to hold the mechanical function buttons. As a result, a volume of the display apparatus as a whole becomes larger, and an overall appearance of the whole display apparatus looks untidy.

A second conventional display apparatus adopts a touch screen for display. The touch screen using graphical user interface (GUI) displays on the display screen thereof buttons, allowing the user to touch directly by the finger or the like for making a selection. However, since the user directly touches the display screen, the touch screen thereupon is easily scratched or damaged.

Therefore, there is a need for an improved display apparatus and touch-based method therefore which can overcome the above-mentioned problems.

### SUMMARY

A display apparatus is provided. The display apparatus includes a screen and a frame. The frame connects the screen. The frame further includes a first touch sensitive unit and at least a touch sensitive region. The first touch sensitive unit is for generating sensing signals to activate navigation icons on the screen, each of the navigation icons indicating a function. The touch sensitive region is for generating sensing signals to perform the functions indicated by the navigation icons. The touch sensitive region has a plurality of second touch sensitive units beneath thereof.

A touch-based method for a display apparatus is also provided. The method includes the steps of: (a) providing a display apparatus, the display apparatus including a screen and a frame, the frame connecting the screen and including a first touch sensitive unit and at least a touch sensitive region, the touch sensitive region having a plurality of second touch sensitive units beneath thereof; (b) receiving and recognizing sensing signals from the first touch sensitive unit; (c) activating navigation icons on the screen according to the sensing signals from the first touch sensitive unit, each of the navigation icons indicating a function; (d) receiving and recognizing sensing signals from the second touch sensitive units; (e) performing the functions indicated by the navigation icons according to the sensing signals from the second touch sensitive units; and (f) closing the navigation icons when a duration of not receiving sensing signals from the second touch sensitive units reaches a first preset value.

Another touch-based method for a display apparatus is further provided. The method includes the steps of: (a) providing a display apparatus, the display apparatus including a screen and a frame, the frame connecting the screen and including a first touch sensitive unit and at least a touch sensitive region, the touch sensitive region having a plurality of second touch sensitive units beneath thereof; (b) activating navigation icons on the screen when receiving sensing signals from the first touch sensitive unit, each of the navigation icons indicating a function; and (c) performing the functions indicated by the navigation icons when receiving sensing signals from the second touch sensitive units.

Other advantages and novel features will be drawn from the following detailed description with reference to the attached drawings, in which:

### BRIEF DESCRIPTION OF DRAWINGS

FIG. 1 is an exemplary schematic diagram of a display apparatus including a screen and a frame in accordance with a first preferred embodiment of the present invention, the screen showing navigation icons thereon, and the frame including a plurality of touch sensitive regions and a touch sensitive unit thereon;

FIG. 2 is another exemplary schematic diagram of a display apparatus including a screen and a frame in accordance with a second preferred embodiment of the present invention, the screen showing navigation icons thereon, and the frame including a plurality of touch sensitive regions, a touch sensitive unit, and a power button thereon;

FIG. 3 is a block diagram of a hardware infrastructure of a sensing signal processing circuit of the touch sensitive unit of FIG. 1 or FIG. 2, with the signal processing circuit connecting to a processing unit;

FIG. 4 is an exemplary block diagram of hardware infrastructure of an electronic book reading apparatus, the electronic book reading apparatus including the display apparatus of FIG. 1 or FIG. 2;

FIG. 5 is a flowchart of a preferred touch-based method for a display apparatus in accordance with a preferred embodiment of the present invention;

FIG. 6 is a flowchart further detailing steps involving a first preferred touch-based method for the display apparatus of FIG. 1; and

FIG. 7 is a flowchart further detailing steps involving a second preferred touch-based method for the display apparatus of FIG. 2.

### DETAILED DESCRIPTION

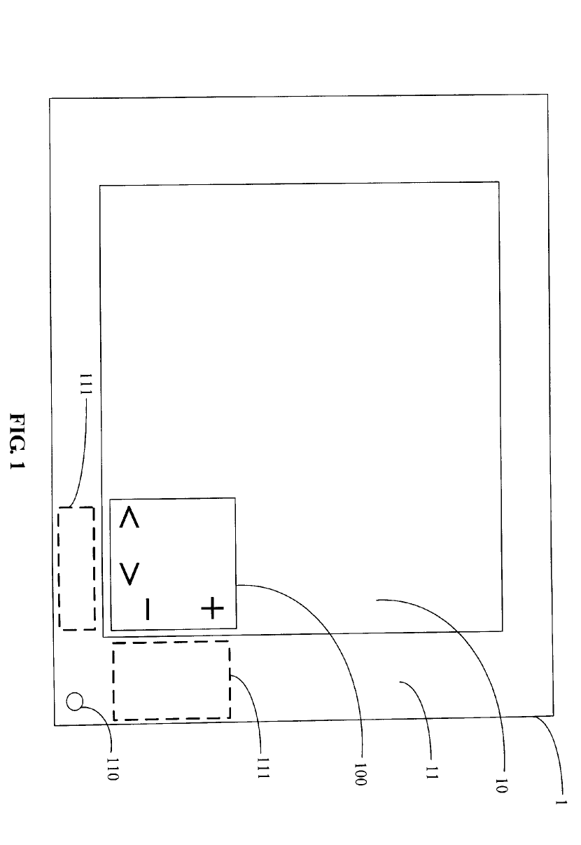

FIG. 1 is an exemplary schematic diagram of a display apparatus in accordance with a first preferred embodiment of the present invention. The display apparatus 1 includes a screen 10 and a frame 11. The frame 11 includes a touch sensitive unit 110 thereon. The touch sensitive unit 110 can be positioned in any appropriate location desired. For simplicity, in such case, the touch sensitive unit 110 is positioned in the location as shown in FIG. 1. The touch sensitive unit 110 is designated a coordinate for identifying itself. The touch sensitive unit 110 further includes a sensing signal processing circuit 112 (described in more detail below) for generating sensing signals in response to a touch operation thereon. When the display apparatus 1 is in a power-off state, the sensing signal processing circuit 112 of the touch sensitive unit 110 generates sensing signals to power on the display apparatus 1 in response to the touch operation on the touch sensitive unit 110, consequently, the display apparatus 1 enters a power-on state. During power-on state, the sensing signal processing circuit 112 of the touch sensitive unit 110 further generates sensing signals to activate navigation icons 100 on the screen 10 in response to the touch operation on the touch sensitive unit 110.

Each navigation icons 100 indicates a function it can perform. The navigation icons, as well as the touch sensitive unit 110, can be positioned in any appropriate location desired. In such case, the navigation icons 100 are positioned in the location as that shown in FIG. 1. That is, the navigation icons 100 are in the down right corner of the screen 10, furthermore, for simplicity, two navigation icons 100 are on the right of the screen 10 and two navigation icons 100 are at the bottom of the screen 10. However, the arrangement of the navigation icons 100 are not to be construed as being limited thereto.

Corresponding to the navigation icons 100, the frame 11 further provides a plurality of touch sensitive regions 111 (each symbolically indicated as a dashed rectangular outline) for touching and to select performing the functions indicated by the navigation icons 100. That is, a touch sensitive region 111, corresponding to the two navigation icons 100 on the right of the screen 10, is positioned on the right side of the frame 11, similarly, a touch sensitive region 111, corresponding to the two navigation icons 100 at the bottom of the screen 10, is positioned at the underside of the frame 11. However, the number and the locations of the touch sensitive regions 111 can be different in other embodiments.

Each touch sensitive region 111 further has a plurality of touch sensitive units (not shown) beneath thereof. Each touch sensitive unit beneath the touch sensitive region 111 matches a navigation icon 100, and has a sensing signal processing circuit 112 for generating a sensing signal to perform the function indicated by the matched navigation icon 100 in response to touch operations on a corresponding location of the touch sensitive region 111. Each touch sensitive unit beneath the touch sensitive region 111, as well as the touch sensitive unit 110, is further designated a coordinate for identifying itself.

The display apparatus 1 further includes a processing unit 12 (not shown). The processing unit 12 receives and recognizes the sensing signals from the touch sensitive unit 110 and the touch sensitive regions 111 according to associated coordinates therewith, and performs corresponding functions. For example, in response to any sensing signals from the touch sensitive unit 110, the processing unit 12 activates the navigation icons 110 on the screen 10; in response to sensing signals from the touch sensitive region 111, the processing unit 12 performs the function indicated by the selected navigation icon 100. Furthermore, the processing unit 12 closes the navigation icons 100, if a first duration of not receiving sensing signals from the touch sensitive regions reaches a first preset value. Moreover, the processing unit 12 cuts off power supply to the display unit, if a second duration of receiving the sensing signal from the touch sensitive unit 110 reaches a second preset value.

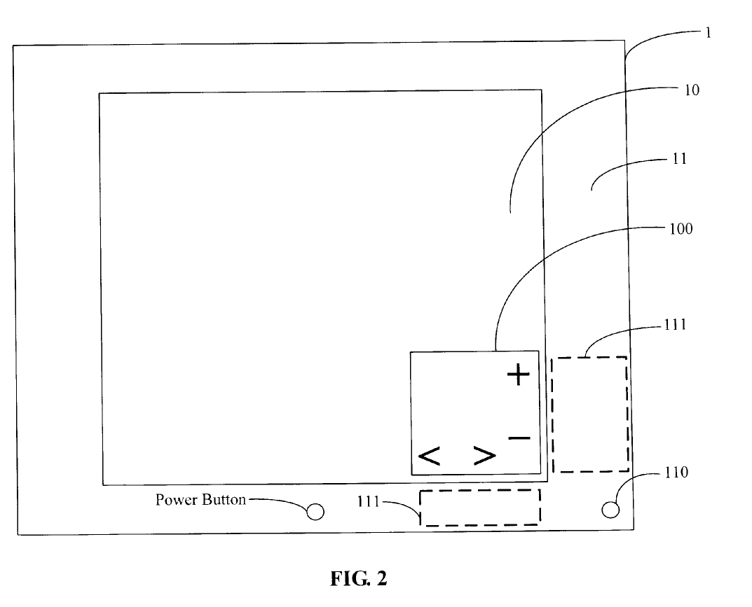

FIG. 2 is another exemplary schematic diagram of a display apparatus in accordance with a second preferred embodiment of the present invention. The display apparatus 1 of this FIG is the same as that shown in FIG. 1, except that the frame 11 further includes a power button thereon. Consequently, the display apparatus 1 is powered on/off through the power button but not the touch sensitive unit 110, as compared to FIG. 1.

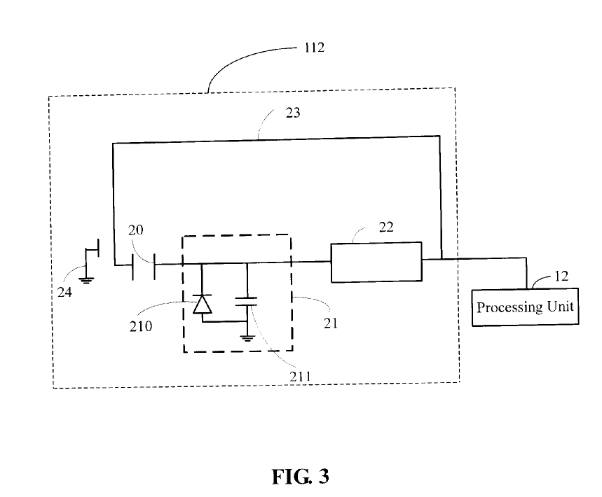

FIG. 3 is a block diagram of a hardware infrastructure of a sensing signal processing circuit of the touch sensitive unit of FIG. 1 or FIG. 2, with the signal processing circuit 112 connecting to the processing unit 12. The touch sensitive unit can be the touch sensitive unit 110 or the touch sensitive units beneath the touch sensitive regions 111. The sensing signal processing circuit 112 mainly includes an antenna 20, a clamping circuit 21, a detector 22, a feedback line 23, and a grounding line 24. The antenna 20 is connected to the clamping circuit 21. The clamping circuit 21 is connected to an input end of the detector 22. An output end of the detector 22 is respectively connected to the processing unit 12 and one end of the feedback line 23. The feedback line 23 forms a positive feedback circuit with the antenna 21. The grounding line 24, namely a space between two adjacent touch sensitive units, is for spacing the touch sensitive units therebetween.

The human body is itself electrically charged with noise and static signals. Therefore, when a user touches the touch sensitive unit 110 or the touch sensitive regions 111, the noise and static signals of the user flow through the antenna 20. The antenna 20 transmits the noise and static signals to the clamping circuit 21. However, the static electrical signals may cause interference to the noise, and may even fry the detector 22. In addition, a strong noise may adversely influence a resulting output for the processing unit; that is, the sensitivity of the touch sensitive unit 110 may be diminished. Accordingly, the clamping circuit 21 is for eliminating the static signals and for reducing the noise, thus improving the sensitivity accuracy of the touch sensitive unit. The clamping circuit 21 includes a diode 210, and a capacitor 211. The anode of the diode 210 is connected to the antenna 20, while the cathode is connected to ground. Upon receiving the noise and static signals, the diode 210 filters out the static signals to ground so as to avoid frying the detector 22, and reducing the noise transmitting to the capacitor 211. The capacitor 211 further leaks a portion of the reduced noise to ground. Thus the reduced noise is further weakened, thereby obtaining a more accurate sensitivity. The detector 22 has a high input impedance, so as to easily detect the reduced and weakened noise received from the input end of the detector 22. The detector 22 then converts the further reduced and weakened noise into digital signals, namely the sensing signals, and transmits the digital signals through the output end of the detector 22 to the processing unit 12 to perform corresponding controls. Furthermore, because the feedback line 23 forms a positive feedback circuit with the antenna 20, the noise generated as the user touches the edge of the touch sensitive unit is filtered, thereby further improving the sensitivity accuracy of the touch sensitive unit.

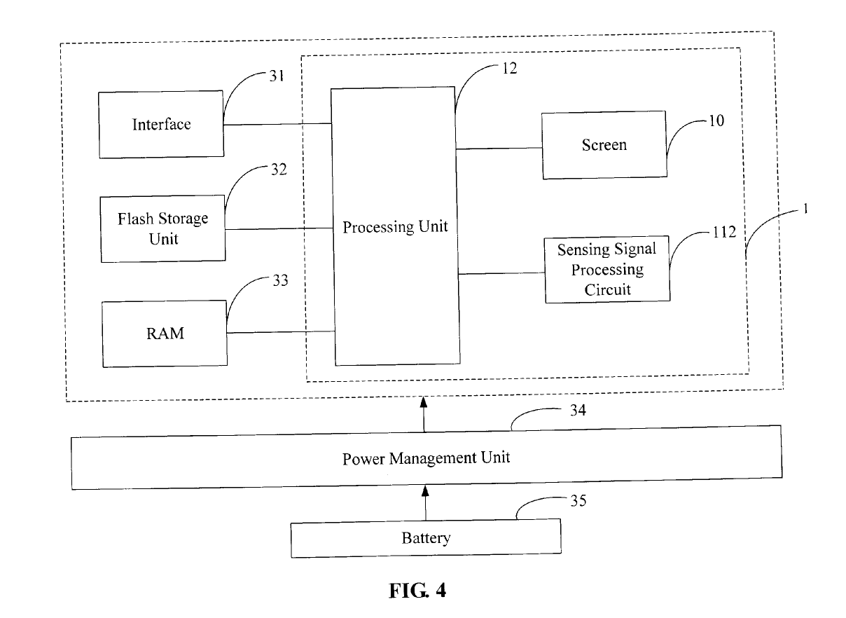

FIG. 4 is an exemplary block diagram of hardware infrastructure of an electronic book reading apparatus, the electronic book reading apparatus including the display apparatus 1 of FIG. 1 or FIG. 2. The electronic book reading apparatus (hereinafter, “the reading apparatus”) mainly includes an interface 31, a flash storage unit 32, an RAM 33, a power management unit 34, a battery 35, and the display apparatus 1 of FIG. 1 or FIG. 2. The display apparatus 1 includes the screen 10, a plurality of sensing signal processing circuits 112 (only one shown), and the processing unit 12 therein.

Referring to FIG. 1 or FIG. 2, the touch sensitive unit 110 and the touch sensitive regions 111 essentially serve as function buttons of the display apparatus 1. Accordingly, the user of the reading apparatus can touch the touch sensitive unit 110 or the touch sensitive regions 111 to perform desired functions. For example, the user may touch the touch sensitive unit 110 to activate the navigation icons 100 on the screen 10. Under the indications of the navigation icons 100, the user can further touch the touch sensitive regions 111 matching the desired navigation icons 100, thereby performing the functions indicated by the navigation icons 100. Additionally, the user may turn off the display apparatus 1 by continuously touching the touch sensitive unit 110 over the second preset value.

In addition, because the touch sensitive unit for performing the functions are beneath the touch sensitive region 111, the frame 11 can retain its neatness, regardless of how many touch sensitive units beneath the touch sensitive regions 111 are adopted. Furthermore, since the surface areas of either the touch sensitive unit 110 or the touch sensitive regions 111 can be designed in smaller sizes, the frame 11 of the display apparatus 1 thereupon can be designed in a narrower size, whereas the screen 10 thereof can be designed in a larger size, thereby the reading apparatus may not only obtain a neater appearance but may also own a larger screen for display.

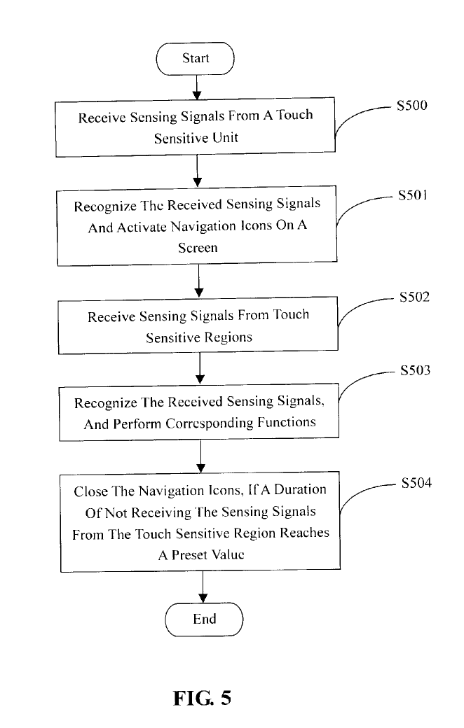

FIG. 5 is a flowchart of a preferred touch-based method for the display apparatus in accordance with a preferred embodiment of the present invention. In step S500, the processing unit 12 receives sensing signals from the sensing signal processing circuit 112 of the touch sensitive unit 110, in response to a touch operation on the touch sensitive unit 110. In step S501, the processing unit 12 recognizes the sensing signals from the touch sensitive unit 110 according to an associated coordinate therewith, and activates navigation icons 100 on the screen 10. In step S502, the processing unit 12 receives sensing signals from the sensing signal processing circuits 112 beneath the touch sensitive regions 111 in response to touch operations on the touch sensitive regions 111. In step S503, the processing unit 12 recognizes the sensing signals from the touch sensitive regions 111 according to associated coordinates therewith, and performs functions indicated by selected navigation icons 100. In step S504, the processing unit 12 closes the navigation icons 100, if a duration of not receiving the sensing signals from the touch sensitive regions 111 reaches a preset value.

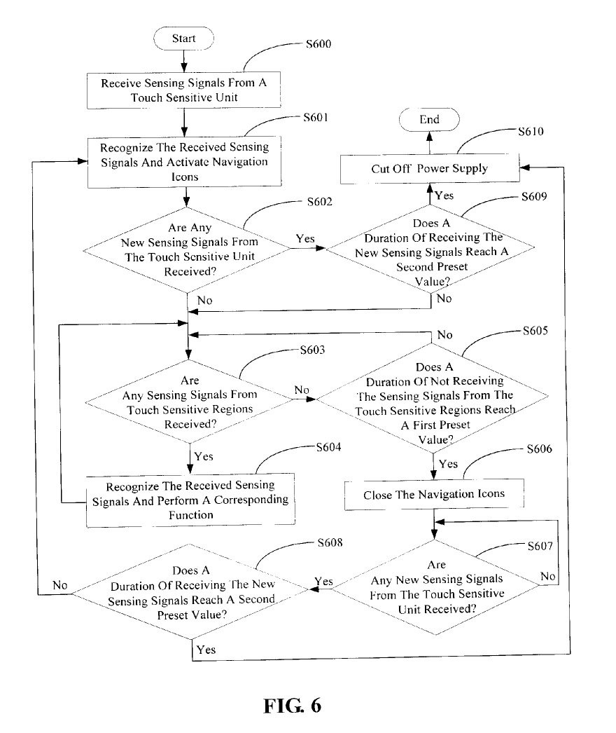

FIG. 6 is a flowchart further detailing steps involving a first preferred touch-based method for the display apparatus of FIG. 1. In step S600, the processing unit 12 receives sensing signals from the sensing signal processing circuit 112 of the touch sensitive unit 110. In step S601, the processing unit 12 recognizes the sensing signals according to the associated coordinates therewith, and activates the navigation icons 100 on the screen 10. In step S602, the processing unit 12 determines whether it receives any new sensing signals from the sensing signal processing circuit 112 of the touch sensitive unit 110. If so, the procedure goes to step S609 described later.

If not, in step S603, the processing unit 12 determines whether it receives any sensing signals from the sensing signal processing circuit 112 of the touch sensitive regions 111. If so, in step S604, the processing unit 12 recognizes the sensing signals according to the associated coordinate therewith, and performs the function indicated by the selected navigation icon 100, and the procedure returns to step S603. Otherwise, in step S605, the processing unit 12 determines whether the duration of not receiving the sensing signals from the touch sensitive regions 111 reaches a first preset value. If the duration doesn't reach the first preset value, the procedure returns to step S603 described above. If the duration reaches the first preset value, the processing unit 12 closes the navigation icons 100 and goes to S607.

In step S607, the processing unit 12 determines whether it receives any new sensing signals from the sensing signal processing circuit 112 of the touch sensitive unit 110. If not receiving any new sensing signals from the touch sensitive unit 110, step S607 continues executing. If received, the processing unit 12 determines whether the duration of continuously receiving the new sensing signals from the touch sensitive unit 110 reaches a second preset value. If the duration doesn't reach the second preset value, the procedure returns to step S601 described above. If the duration reaches the second preset value, in step S610, the processing unit 12 cuts off power supply to the display unit, and the procedure is finished.

In step S609, the processing unit 12 determines whether the duration of continuously receiving the new sensing signals from the touch sensitive unit 110 reaches the second preset value. If the duration doesn't reach the second preset value, the procedure returns to step S603 described above. If the duration reaches the second preset value, the procedure goes to step S610 described above.

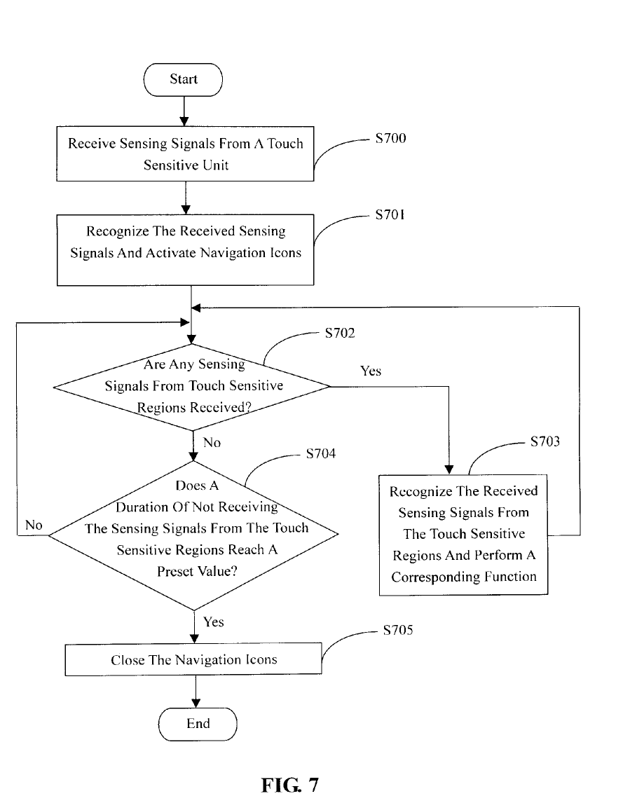

FIG. 7 is a flowchart further detailing steps involving a second preferred touch-based method for the display apparatus of FIG. 2. In step S700, the processing unit 12 receives sensing signals from the sensing signal processing circuit 112 of the touch sensitive unit 110. In step S701, the processing unit 12 recognizes the sensing signals according to the associated coordinates therewith, and activates the navigation icons 100 on the screen 10. In step S702, the processing unit 12 determines whether it receives sensing signals from sensing signal processing circuit 112 of the touch sensitive regions 111. If received, in step S703, the processing unit 12 recognizes the sensing signals according to the associated coordinates therewith, and performs the function indicated by the selected navigation icon 100, and the procedure goes to step S702. If not received, the processing unit 12 determines whether the duration of not receiving sensing signals from the touch sensitive regions 111 reaches a preset value. If the duration doesn't reach the preset value, the procedure returns to step S702 described above. Otherwise, in step S705, the processing unit 12 closes the navigation icons 100, and the procedure is finished.

Although the present invention has been specifically described on the basis of preferred embodiments and preferred methods thereof, the invention is not to be construed as being limited thereto. Various changes or modifications may be made to the embodiments and methods without departing from the scope and spirit of the invention.

What is claimed is:

1. A display apparatus comprising a screen and a frame, the frame connecting the screen, wherein: the frame comprises:
a first touch sensitive unit for generating sensing signals to activate navigation icons on the screen, each of the navigation icons indicating a function; and
at least a touch sensitive region for generating sensing signals to perform the functions indicated by the navigation icons, the touch sensitive region having a plurality of second touch sensitive units beneath thereof.

2. The display apparatus according to claim 1, further comprising a processing unit, wherein the processing unit receives the sensing signals from the first touch sensitive unit and the touch sensitive region and performs a corresponding operation according to the received sensing signals.

3. The display apparatus according to claim 2, wherein the operation is selected from the group consisting of activating the navigation icons on the screen and performing the functions indicated by the navigation icons.

4. The display apparatus according to claim 3, wherein the first touch sensitive unit further comprises a sensing signal processing circuit for generating the sensing signals in response to a touch operation, and the first touch sensitive unit is designated a coordinate for identification.

5. The display apparatus according to claim 4, wherein each of the second touch sensitive units further comprises a sensing signal processing circuit for generating the sensing signals in response to a touch operation, and each of the second touch sensitive units is designated a coordinate for identification.

6. The display apparatus according to claim 5, wherein the processing unit further closes the navigation icons when a duration of not receiving sensing signals from the second touch sensitive units reaches a first preset value.

7. The display apparatus according to claim 6, wherein the processing unit further turns off the display apparatus when a duration of receiving the sensing signals from the first touch sensitive unit reaches a second preset value.

8. The display apparatus according to claim 4, wherein the sensing signal from the first touch sensitive unit is further employed to power on the display apparatus when the display apparatus is in a power-off state.

9. A touch-based method for a display apparatus, the method comprising the steps of:
providing a display apparatus which comprises a screen and a frame connecting the screen, the frame comprising a first touch sensitive unit and at least a touch sensitive region, the touch sensitive region having a plurality of second touch sensitive units beneath thereof;
receiving and recognizing sensing signals from the first touch sensitive unit;
activating navigation icons on the screen according to the sensing signals from the first touch sensitive unit, each of the navigation icons indicating a function;
receiving and recognizing sensing signals from the second touch sensitive units;
performing the functions indicated by the navigation icons according to the sensing signals from the second touch sensitive units; and
closing the navigation icons when a duration of not receiving sensing signals from the second touch sensitive units reaches a first preset value.

10. The touch-based method according to claim 9, further comprising the step of:
turning off the display apparatus when a duration of receiving sensing signals from the first touch sensitive unit reaches a second preset value.

11. The touch-based method according to claim 9, further comprising the step of:
powering on the display apparatus when receiving sensing signals from the first touch sensitive unit and the display apparatus is in a power-off state.

12. A touch-based method for a display apparatus, the method comprising the steps of:
providing a display apparatus comprising a screen and a frame connecting the screen, the frame comprising a first touch sensitive unit and at least a touch sensitive region, the touch sensitive region having a plurality of second touch sensitive units beneath thereof;
activating navigation icons on the screen when receiving sensing signals from the first touch sensitive unit, each of the navigation icons indicating a function; and
performing the functions indicated by the navigation icons when receiving sensing signals from the second touch sensitive units.

13. The touch-based method according to claim 12, further comprising the step of:
closing the navigation icons when a duration of not receiving sensing signals from the second touch sensitive units reaches a first preset value.

14. The touch-based method according to claim 13, further comprising the step of:
turning off the display apparatus when a duration of receiving sensing signals from the first touch sensitive unit reaches a second preset value.

15. The touch-based method according to claim 12, further comprising the step of:
powering on the display apparatus when receiving sensing signals from the first touch sensitive unit and the display apparatus is in a power-off state.
